(19) United States
(12) Patent Application Publication
(10) Pub. No.: US 2021/0254904 A1
(43) Pub. Date: Aug. 19, 2021

(54) ADDITIVELY MANUFACTURED HEAT EXCHANGER

(71) Applicant: The Boeing Company, Chicago, IL (US)

(72) Inventors: Bhuvan Bhaskar, Bangalore (IN); Syamala Rao Gude, Bengaluru (IN); Ramanna M. Jakkanagoudar, Bangalore (IN); Harsha Jithendra Pochiraju, Bengaluru (IN); Venkateswara K. Reddy, Bangalore (IN)

(73) Assignee: The Boeing Company, Chicago, IL (US)

(21) Appl. No.: 17/179,327

(22) Filed: Feb. 18, 2021

(30) Foreign Application Priority Data
Feb. 19, 2020 (IN) 202011007124

(51) Int. Cl. F28F 1/12; B33Y 80/00

(52) U.S. Cl. CPC F28F 1/126; B33Y 80/00; F28D 2021/0021; F28F 2215/06; F28F 2255/18

(57) ABSTRACT

An additively manufactured heat exchanger includes a main body and a plurality of wavy fins. The plurality of wavy fins are disposed in the main body to define flow paths for heat transfer. Each wavy fin has an inner wall forming a channel including radiused corners throughout a length of the wavy fin.

### BACKGROUND

Thermal management is a growing field, applicable to a variety of heat-producing equipment ranging from highly compact electronics to jet engines. Effective thermal management improves both performance and reliability of equipment, and can be critical to system function. A variety of cooling technologies have been developed, but use of a liquid coolant such as oil is particularly effective. Often, liquid cooling is accomplished with a heat exchanger, many of which include fins to increase surface area for heat transfer. However, existing heat exchangers can be expensive and labor intensive to manufacture.

In traditional manufacturing methods, forming the complex geometry of fins and channels of a heat exchanger typically requires joining of numerous separate parts through welding, brazing, or mechanical fastening. Such joins reduce heat transfer performance and may be prone to loosening over time. A heat exchanger with reduced production cost and increased heat transfer performance is desirable.

### SUMMARY

The present disclosure provides systems, apparatuses, and methods relating to additively manufactured heat exchangers having wavy fins. In some examples, an additively manufactured heat exchanger includes a main body and a plurality of wavy fins. The plurality of wavy fins is disposed in the main body to define flow paths for heat transfer. Each wavy fin has an inner wall forming a channel including radiused corners throughout a length of the wavy fin.

In some examples, an aircraft includes an aircraft body, an engine, and a heat exchanger device. The engine is connected to the aircraft body and configured to power the aircraft body in a flight mode. The heat exchanger device is configured to cool oil from the engine and has a plurality of wavy fins in a main body. The main body and wavy fins are a single monolithic unit. Each wavy fin has an inner wall forming a channel including radiused corners throughout a length of the wavy fin.

In some examples, a method of manufacturing a heat exchanger includes printing a main body and printing a plurality of wavy fins inside the main body.

Features, functions, and advantages may be achieved independently in various examples of the present disclosure, or may be combined in yet other examples, further details of which can be seen with reference to the following description and drawings.

### BRIEF DESCRIPTION OF THE DRAWINGS

FIG. 1 is a schematic diagram of an illustrative additively manufactured heat exchanger in accordance with aspects of the present disclosure.

FIG. 2 is an isometric view of an illustrative integrated drive generator (IDG) cooler as described herein.

FIG. 3 is a cross-sectional view of the IDG cooler of FIG. 2, along line 3-3.

FIG. 4 is a cutaway view of the IDG cooler of FIG. 2, cut along lines 4-4.

FIG. 5 is a cross-sectional view of the IDG cooler of FIG. 2, long line 5-5.

FIG. 6 is a cutaway view of a portion of a channel structure of the IDG cooler of FIG. 2.

FIG. 7 is an isometric view of the ring strip of the channel structure portion of FIG. 6.

FIG. 8 is a cutaway view of another portion of a channel structure of the IDG cooler of FIG. 2.

FIG. 9 is an isometric view of the riblet cluster of the channel structure portion of FIG. 8.

FIG. 10 is a cross-sectional view of a channel structure of the IDG cooler of FIG. 2.

FIG. 11 is another cross-sectional view of the channel structure of FIG. 10.

FIG. 12 is a cross-sectional view of the ring rib of the channel structure of FIG. 10.

FIG. 13 is a flow chart depicting steps of an illustrative method of additive manufacture according to the present teachings.

FIG. 14 is a schematic diagram of an illustrative additive manufacturing apparatus as described herein.

FIG. 15 is a flow chart depicting steps of an illustrative method for additively manufacturing a heat exchanger according to the present teachings.

FIG. 16 is a flow chart depicting steps of an illustrative aircraft manufacturing and service method.

FIG. 17 is a schematic diagram of an illustrative aircraft.

### DETAILED DESCRIPTION

Various aspects and examples of an additively manufactured heat exchanger having wavy fins, as well as related methods, are described below and illustrated in the associated drawings. Unless otherwise specified, a heat exchanger in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed examples. The following description of various examples is merely illustrative in nature and is in no way intended to limit the disclosure, its application, or uses. Additionally, the advantages provided by the examples described below are illustrative in nature and not all examples provide the same advantages or the same degree of advantages.

This Detailed Description includes the following sections, which follow immediately below: (1) Overview; (2) Examples, Components, and Alternatives; (3) Illustrative Combinations and Additional Examples; (4) Advantages, Features, and Benefits; and (5) Conclusion. The Examples, Components, and Alternatives section is further divided into subsections A through D, each of which is labeled accordingly.

### Overview

In general, an additively manufactured heat exchanger in accordance with the present teachings includes a thermally conductive structure with a first flow path for a first fluid and a second flow path for a second fluid, where the structure is configured to conduct heat between the first fluid and the second fluid. The heat exchanger may be a single additively manufactured unit and may also be referred to as a heat transfer device, a heat sink, and/or a cooler.

The first flow path includes a plurality of channels, where each channel is formed by an inner wall of a fin structure. The second flow path may also include a plurality of channels, and in some examples each channel is formed by an inner wall of a fin structure. The channels of the first flow path are separate from the channels of the second flow path such that first flow path is not in fluid communication with the second flow path. The fin structures have a periodic shape, and may be described as wavy, corrugated, and/or herringbone.

The channel of each fin structure may have a generally rectangular cross-sectional shape. That is, the inner wall of each fin structure may be described as having four sides meeting at four corners. Within examples, the corners are radiused, rounded, filleted, chamfered, and/or beveled. Such alternations to the corner shape may reduce flow constriction and promote a smooth flow of fluid through the channels. For instance, radiused corners help to reduce flow constriction when compared to non-radiused corners. Further, radiused corners promote a smoother flow of fluid through the channels than non-radiused corners. In some examples, fin structures are spaced from adjacent fin structures and in some examples fin structures share walls with and/or are undivided from adjacent fin structures.

Each channel may further include one or more ribs. In such examples, each rib is unitary with the inner wall of the fin structure, and extends from the inner wall into the channel. That is, each rib protrudes into the channel. The ribs may have any appropriate shape, but are configured to reduce a drop in pressure produced in fluid flowing through the channel. For example, a rib may form a continuous ring, or multiple linearly elongate ribs may be disposed in a cluster.

The ribs and/or groupings of multiple ribs may be disposed at intervals along a length of each fin structure. The interval may correspond to a period or wavelength of the periodic shape of the fin structure. For example, a rib may be disposed at each crest of a wave of the fin structure. A single rib configuration may be repeated along a fin structure and/or multiple rib configurations may be included in a fin structure. The fin structures of the heat exchanger may have matching rib configurations and/or placement of ribs, or the ribs and placements may vary between fin structures.

FIG. 1 is a schematic diagram of an illustrative heat exchanger 110. The heat exchanger includes a main body 112 with a first fluid path 114 and a second fluid path 116. Each path includes an intake 118 and an outtake 120. A first fluid 122 follows first path 114 and a second fluid 124 follows second path 116. When entering heat exchanger 110 through intakes 118, second fluid 124 is hotter than first fluid 122. As the two fluids travel through heat exchanger 110, heat is exchanged such that first fluid 122 leaves outtake 120 of first path 114 heated and second fluid 124 leaves outtake 120 of second path 116 cooled.

First and second fluids 122, 124 may be supplied to intakes 118 by separate fluid systems, each including a pump or other compressor and a fluid source. The fluids may include, but are not limited to, dielectric liquid coolants such as silicone oils, non-dielectric liquid coolants such as aqueous solutions of ethylene glycol, newer coolants such as nanofluids or ionic liquids, and/or or gases such as nitrogen or atmospheric air. For example, first fluid 122 may be aircraft engine oil and second fluid 124 may be pressurized air from the aircraft environmental systems.

First path 114 includes a plurality of channels 126. Each channel is formed in a fin 128, and defined by an internal wall 130 of the fin. The internal wall further defines curved corners 132 of the channel and includes one or more ribs 134 as described above.

Second path 116 also includes a plurality of channels 126. In some examples, the channels of the second path are also formed in fins and may include curved corners and/or ribs. Heat is exchanged between first fluid 122 and second fluid 124 through fins 128 and/or through main body 112 of the heat exchanger.

Heat exchanger 110 comprises a thermally conductive material, which may be a laser sintered metal or a fused deposition molded metal. In some examples, the cold plate includes aluminum, copper, titanium, and/or an alloy thereof. The heat exchanger may include multiple materials, or may be produced from a single material. Thermal conductivity, specific heat, density, and phase transition temperatures, along with other factors, may be considered in selecting a material or combination of materials. Appropriate or desirable materials may depend on an intended application and a selected additive manufacturing method.

In some examples, heat exchanger 110 is designed to have functionality equivalent to an existing heat exchanger design and is configured to connect to a generally matching fluid supply and/or recycling system as the existing heat exchanger design. For example, heat exchanger 110 may be configured to directly replace an existing integrated drive generator (IDG) cooler.

Heat exchanger 110 is partially or entirely unitary. In some examples, main body 112, first and second paths 114, 116, channels 126, fins 128, internal walls 130, corners 132, ribs 134 and/or any other portions of the heat exchanger comprise a single monolithic structure. The heat exchanger may be additively manufactured in one process, without need for assembly of separate parts. The heat exchanger may also be printed without secondary supports that require removal after additive manufacture.

Heat exchanger 110 may have improved reliability, as a result of unitary construction. Less than optimal performance of the heat exchanger 110 related to issues with connection or interaction of parts may be eliminated. Part count, production time, and manufacturing costs may be reduced. Unitary construction may also improve heat transfer between fluids 122, 124 by removing joints and interfaces and increasing surface area of the heat exchanger.

### Examples, Components, and Alternatives

The following sections describe selected aspects of exemplary heat exchangers as well as related systems and/or methods. The examples in these sections are intended for illustration and should not be interpreted as limiting the entire scope of the present disclosure. Terms such as “upper”, “lower”, “left”, and “right” may be used to in the context of the drawings to refer to relative positions of the described components, but it should be understood that any of the described components or heat exchangers may be used in any orientation. Each section may include one or more distinct examples, and/or contextual or related information, function, and/or structure.

### A. Illustrative Air Cooled Integrated Drive Generator Oil Cooler

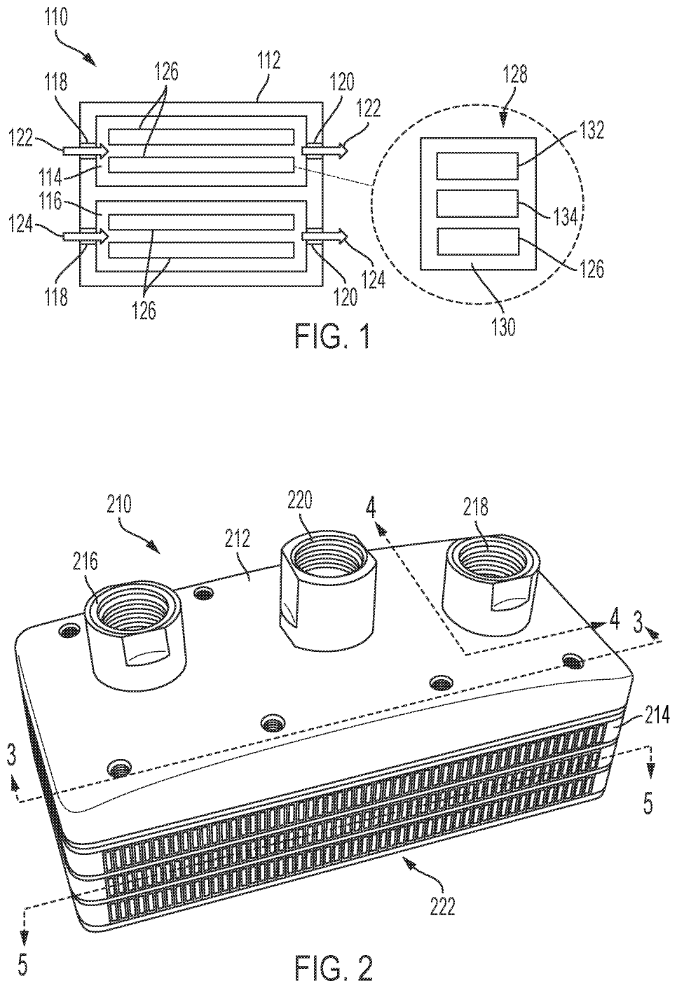

As shown in FIGS. 2-11, this section describes an illustrative additively manufactured heat exchanger 210. In the illustrated example, additively manufactured heat exchanger 210 is an air cooled integrated drive generator (IDG) oil cooler, which is an example of an additively manufactured heat exchanger, as described above. The cooler includes an interface plate 212 fastened to a main body 214. Each of the interface plate and the main body may be additively manufactured then fastened together, for instance by bolts extending through the interface plate to engage the main body.

Interface plate 212 includes an oil intake 216, an oil outtake 218, and a bypass 220. Hot oil from an IDG may be fed through oil intake 216 into main body 214. Once cooled, the oil may be fed from the main body out through oil outtake 218 to a filter, recycling system, and/or returned to the IDG. Interface plate 212 may be configured to direct oil flow and not for thermal conduction. Accordingly, the interface plate may be additively manufactured from a material selected for weight and structural properties and may have limited thermal conductivity. Structural portions of the interface plate may also be printed with a lattice structure fill rather than as a solid material, thereby reducing overall weight of heat exchanger 210.

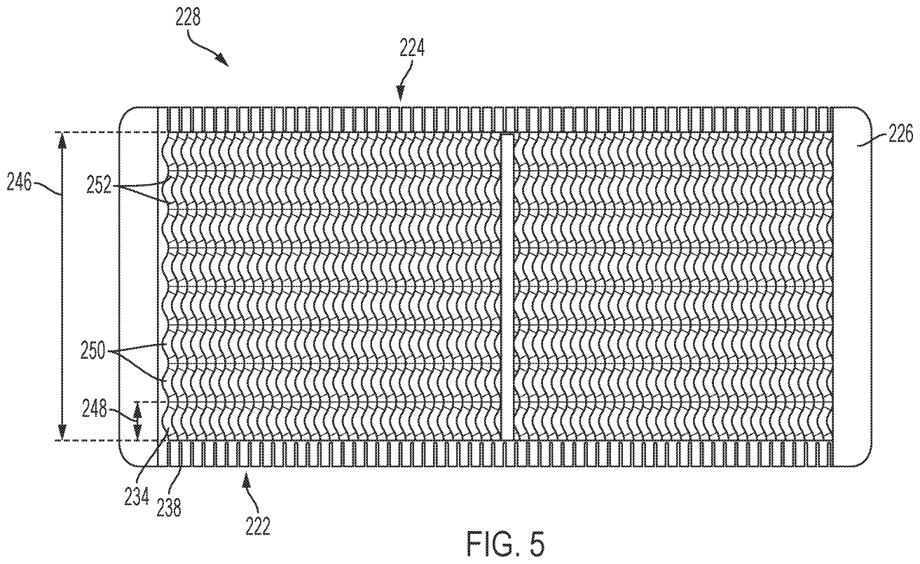

Main body 214 is generally rectangular, with four sides including an air intake face 222, and air outtake face 224 (not pictured in FIG. 2, but indicated in FIG. 5) and two side walls 226. The main body is made up of a plurality of stacked channel layers, including three air channel layers 228. Air intake face 222 includes a plurality of openings into the three air channel layers and is configured to intake environmental air. In some examples, air intake face 222 is configured to interface with a fan and/or an air compressor for delivery of pressurized air.

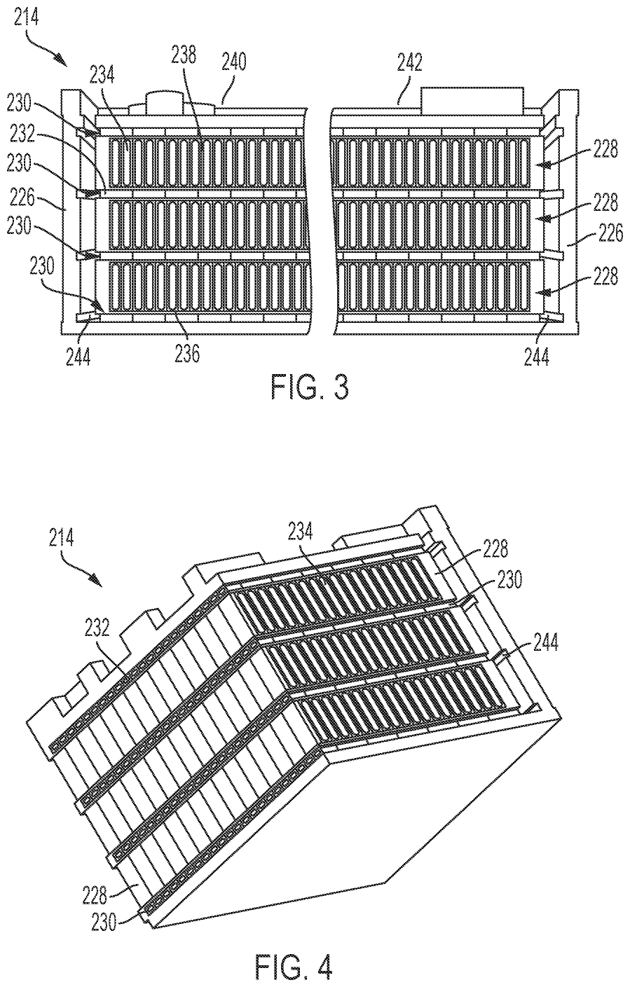

As shown in FIG. 3, the plurality of stacked layers of main body 214 further includes four oil channel layers 230. The oil channel layers are alternatively stacked with the air channel layers. That is, each air channel layer 228 may be described as sandwiched between two oil channel layers 230. As oil and air pass through main body 214, heat is transferred between layers, from the oil to the air.

In the present example, the main body includes seven total layers. In general, heat exchanger 210 may include any number of layers and any ratio and/or arrangement of oil channel and air channel layers. Preferably, each oil channel layer is adjacent at least one air channel layer, to facilitate heat transfer between the two fluids.

As shown more clearly in FIG. 4, each layer of oil channel layers 230 and air channel layers 228 includes a plurality of elongate channels extending across main body 214 and configured to direct fluid flow. Channels 232 of oil channel layers 230 extend between the side walls of the main body in a first direction, while channels 234 of air channel layers 228 extend between the air intake face and the air outtake face of the main body in a second direction. That is, the channels of the oil and air channel layers extend generally perpendicular to each other. Heat exchanger/IDG cooler 210 may be described as a cross-flow heat exchanger.

Heat exchanger 210 may also be described as a plate and fin heat exchanger. Each oil channel layer 230 may be described as including upper and lower walls, or as extending between plates 236. Channels 234 of each air channel layer 228 may be described as separated by a plurality of vertical walls, or as each being defined by an internal wall of a fin 238. Fins 238 extend from plates 236 and are arranged in stacked arrays. Heat is therefore transferred from oil in channels 232 to plates 236, from the plates to fins 238, and from the fins to air in channels 234.

Referring again to FIG. 3, main body 214 further includes an oil inlet plenum 240, an oil outlet plenum 242, and vertical channels 244. The plenums are cooperatively defined between main body 214 and interface plate 212. Hot oil from the intake enters inlet plenum 240 and proceeds down the corresponding one of vertical channels 244. Vertical channels 244 are in fluid communication with the ends of channels 232 of oil channel layers 230, such that oil flowing from inlet plenum 240 along the corresponding vertical channel enters each oil channel layer. Once heat is exchanged with air channel layers 228, the oil is output from channels 232 into the vertical channel 244 corresponding to outlet plenum 242. Cooled oil flows from the outlet plenum through the oil outtake of the interface plate.

FIG. 5 is a cross-sectional view of one of air channel layers 228 of heat exchanger 210. The below description may be understood to apply similarly to the remaining two layers. As noted above, layer 228 includes a plurality of channels 234 which are each defined by an internal wall of a fin 238. Channels 234 may also be described as defined between separating walls. Fins 238 have a periodic shape and may be described as wavy. Each fin extends from air intake face 222 to air outtake face 224, with a length 246.

In the present example, fins 238 have an approximately sinusoidal shape defined by a periodic length or wavelength 248. Each fin may be described as made up of multiple identical wave segments 250, each wave segment extending one wavelength of the fin. In the present example, each fin 238 includes eight wave segments 250. In general, the fins may include any number of wave segments, as determined by a desired length 246 of the fins, and the wavelength 248 characteristic of a selected wave shape of the fins. In the present example, heat exchanger 210 is approximately four to five inches across, from air intake face 222 to air outtake face 224. Fin length 246 is approximately 3.5 to 4.5 inches, and wavelength 248 is approximately half of an inch.

Fins 238 are all aligned and parallel, arranged as a regular array of fins. Each fin shares a wall with an adjacent fin on both first and second sides, except for one left-most and one right-most fin which each share a wall with an adjacent fin on just one side. Fins 238 may be described as joined to adjacent fins, and form a unitary and/or monolithic structure of layer 228.

Each fin 238 further includes a plurality of ribs 252. As shown in FIG. 5, and described further with reference to FIG. 11 below, each wave segment includes a pair of two ribs 252. Each pair of ribs is correspondingly positioned relative to the periodic wave shape of the fin. In some examples, each wave segment includes a single rib and/or only some subset of wave segments includes ribs.

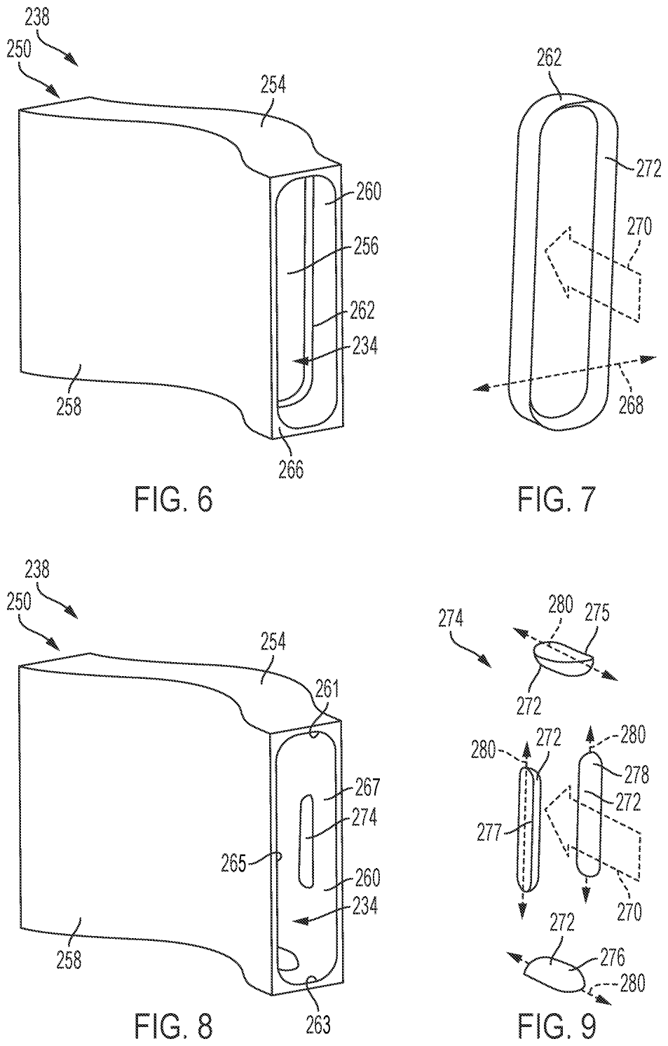

Two illustrative configurations of one or more ribs are depicted in FIGS. 6-9. In the present example, ribs 252 are ring strips, as described with reference to FIGS. 6 and 7. In general, each fin may include a single rib configuration, each wave segment may include only one rib configuration, and/or the fins and wave segments may include any desired combination and/or pattern of ribs.

Quantity, placement, and configuration of ribs may be selected according to properties of the IDG cooler such as a size of channels 234 and/or the wave shape of fins 238, and/or may be selected according to properties of the air or other fluid flowing through channels 234 such as pressure and/or viscosity. The ribs are designed to promote airflow through air channel layer 228 that enhances heat transfer between the air and fins, and reduces air pressure drop across the layer.

FIG. 6 shows an isolated wave segment 250 of an illustrative one of fins 238. The below description may be understood to apply similarly to the remaining wave segments and fins. Fin 238 includes a wall 254 with an inner surface 256. Wall 254 may be described as including an outer wall 258 and an inner wall 260. In layer 228, as shown in FIG. 5, outer wall 258 may be common between adjacent fins 238 and/or adjacent outer walls may be part of a single dividing wall structure.

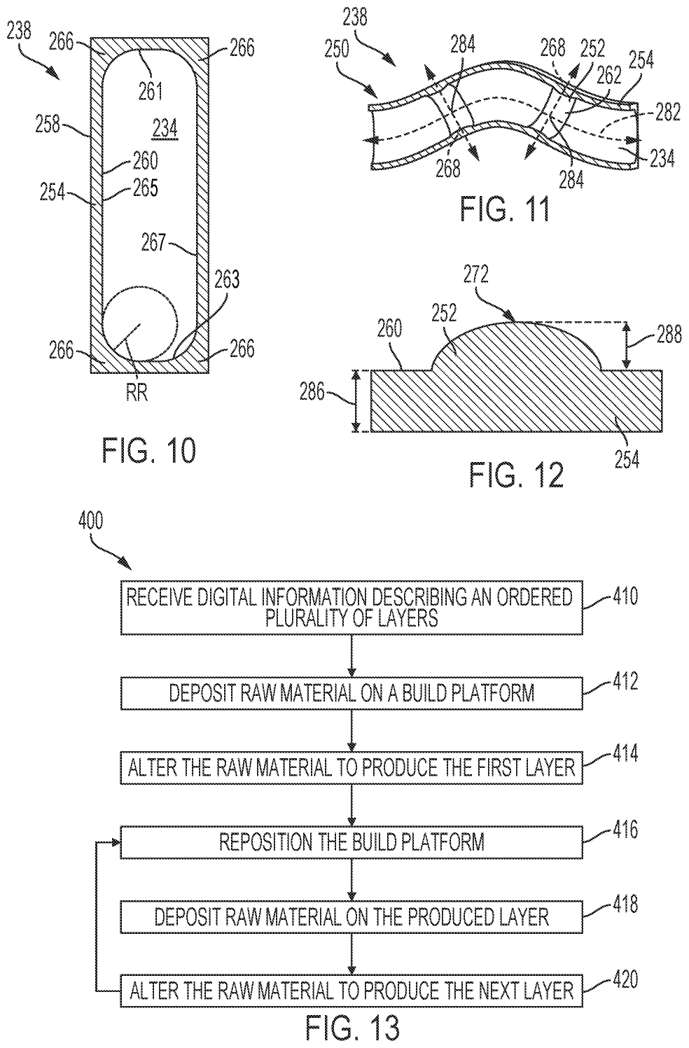

Referring again to FIG. 6, inner wall 260 defines channel 234 and is generally rectangular in cross-section. The inner wall includes four sides, which meet at four corners 266. The corners are rounded or radiused, as described further with reference to FIG. 10, below. Extending from inner wall 260 is a ring strip 262, which is an example of a rib 252 as described above. The ring strip extends from inner wall 260 into channel 234 and forms a continuous ring around inner surface 256. The ring strip is unitary with inner wall 260, and/or printed as part of the inner wall.

As shown in FIG. 7, ring strip 262 may be described as having a lateral axis 268. The ring strip is positioned in the channel of the fin such that lateral axis 268 of the ring strip is generally perpendicular to a flow path 270 of air through the channel. The ring strip has a curved, or semi-ellipsoid surface 272. Ring strip 262 is configured to increase surface area of inner wall 260 and improve airflow through channel 234. In general, dimensions, geometry, and/or position of the ring strip may be selected according to desired airflow and heat transfer properties.

FIG. 8 shows wave segment 250 with a cluster of linear riblets 274. Cluster 274 is another example of one or more ribs that may be on inner wall 260, as described above. In some examples, fins including only ring strips 262 may experience diminishing flow improvements from the ring strips along the length of the fin. In such examples, one or more clusters 274 may be included in a fin to enhance flow mixing and thereby improve heat transfer between the airflow and the fin.

The four sides of inner wall 260 may be described as an upper side 261, a lower side 263, a left side 265, and a right side 267. Cluster 274 includes a separate linear riblet extending from each of the four sides. That is, the cluster includes an upper riblet 275, a lower riblet 276, a left riblet 277, and a right riblet 278. Upper and lower riblets 275, 276 are matching in shape and orientation, while left and right riblets 277, 278 are also matching in shape and orientation, but differ from the upper and lower riblets.

More specifically, each riblet is elongate and has a long axis 280. The long axes of upper and lower riblets 275, 276 are mutually parallel and also parallel to flow path 270. The long axes of left and right riblets 277, 278 are mutually parallel, but perpendicular to flow path 270. The left and right riblets have a greater length along long axis 280 than the upper and lower riblets, but all four riblets have an approximately equal width. Each riblet is approximately centered on the corresponding side of inner wall 260. Each riblet has a curved or semi-ellipsoid surface 272. In general, dimensions, geometry, and/or position of each individual linear riblet as well as the number of riblets and relative positions within the cluster may be selected according to desired airflow and heat transfer properties.

FIG. 10 is a cross-sectional view of fin 238. As shown, wall 254 has an approximately equal thickness on each side of the fin, but increases in thickness at corners 266. Each corner is radiused (i.e. rounded). Each corner 266 may be described as having a radius of curvature RR. The corners are radiused along the full length 246 of fin 238, from air intake face 222 to air outtake face 224 (See FIG. 5). In the present example, all four corners have the same radius of curvature, which is between approximately ten and thirty thousandths of an inch (mil).

In some examples, the corners have different curvatures, vary in curvature along the length of the fin, and/or have other shapes such as beveling or chamfering. Radius of curvature RR and/or the shape of corners 266 are selected to smooth airflow through channel 234 and/or provide other desired airflow characteristics. For example, the shape may be selected according to the size of channel 234 relative to a pressure of the air flowing through the channel.

FIG. 11 is another cross-sectional view of wave segment 250 of fin 238, in a plane perpendicular to the view of FIG. 10 and matching the view of FIG. 5. As shown, wave segment 250 includes two ribs 252, more specifically two ring strips 262. The ring strips are positioned in wave segment 250 to improve flow through channel 234. In particular, the ring strips are positioned at the two inflection points of the wave curvature of the wave segment.

In other words, channel 234 of wave segment 250 may be described as having a center line 282. In the present example, center line 282 is sinusoidal and has two inflection points 284. One of the two ring strips 262 is positioned at each inflection point 284, with lateral axis 268 of the ring strip approximately perpendicular to center line 282 at the inflection point. In examples where fin 238 includes one or more clusters of linear riblets instead of or in addition to ring strips 262, the clusters may be centered on inflection points 284.

FIG. 12 is a cross-sectional view of a portion of fin wall 254, including a rib 252. The depicted rib may be a ring strip 262 or a linear riblet of a cluster 274. Rib 252 has a cross-sectional shape of a half-ellipse, forming semi-ellipsoid surface 272. As shown, wall 254 has a thickness 286 and rib 252 has a maximum thickness 288. The wall and rib are a single, unitary or monolithic structure. In the present example, wall thickness 286 and rib thickness 288 are approximately the same, and between about five to ten mil.

Referring back to FIGS. 3-5, all components of main body 214 of heat exchanger 210 as described above are additively manufactured as a single, unitary or monolithic structure. That is, plates 236 and fins 238 of stacked oil channel layers 230 and air channel layers 228, as well as channels 232, 234 and ribs 252 are all printed together as the same structure.

Such unitarity reduces part count and production time over conventionally manufactured IDG coolers. Such unitarity also reduces overall weight and volume of the cooler by as much as ten or fifteen percent, by eliminating constraints of traditional manufacturing. Unitarity and use of a single material in printing also improves heat transfer performance by eliminating joints and interfaces and maximizing surface area. In the present example, heat exchanger 210 includes a single alloy of aluminum printed by Direct Metal Laser Sintering (DMLS).

Additive manufacturing also allows shapes and structures optimal for heat transfer that are not achievable in traditional manufacturing. For example, the sinusoidal curvature or s-shapes of fins 238 and ribs 252 improve surface area but would be challenging and/or impractical to achieve by traditional methods. For another example, inner surfaces of channels 232, 234 may be printed with texturing to increase effective surface area and/or structural features such as side walls 226 may include a surface lattice pattern to allow reduction of volume without sacrificing structural strength.

In the present example, all components of heat exchanger 210 are additively manufactured. In some examples, the cooler includes both additively and traditionally manufactured components. For instance, interface plate 212 may be cast or machined while main body 214 is printed by DMLS.

### B. Illustrative Method of Additive Manufacture

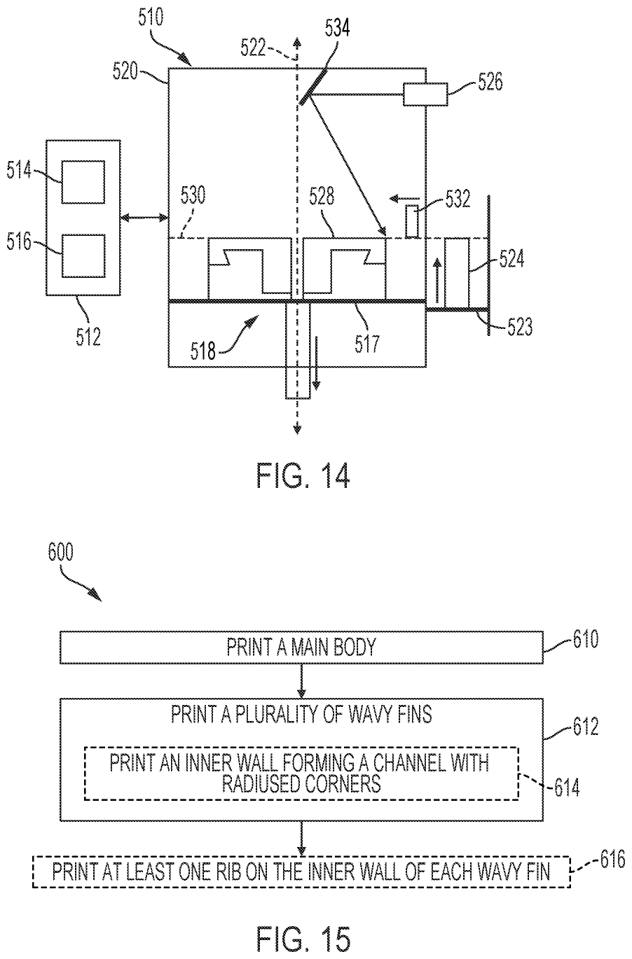

This section describes steps of an illustrative method for additive manufacture of a workpiece by Direct Metal Laser Sintering (DMLS); see FIG. 13. Aspects of an illustrative additive manufacturing device depicted in FIG. 14 may be utilized in the method steps described below. Where appropriate, reference may be made to components and systems that may be used in carrying out each step. These references are for illustration, and are not intended to limit the possible ways of carrying out any particular step of the method.

FIG. 13 is a flowchart illustrating steps performed in an illustrative method, and may not recite the complete process or all steps of the method. Although various steps of method 400 are described below and depicted in FIG. 13, the steps need not necessarily all be performed, and in some cases may be performed simultaneously or in a different order than the order shown.

At step 410, digital information describing an ordered plurality of layers is received. The digital information may be received by a computer controller 512 of a DMLS device 510 as depicted in FIG. 14. The device may also be referred to as a printer, or a fabricator. Computer controller 512 may comprise any data processing system configured to receive digital design information and control functions of printer 510. The illustrative computer controller shown in FIG. 14 includes a processor 514 for controlling printer functions and memory 516 for storing received data.

The received information may include geometric data and/or design details for a plurality of two-dimensional patterns that constitute layers of a three-dimensional object, where the three-dimensional object is a workpiece 528 to be manufactured. In some examples, the workpiece is a heat exchanger or IDG cooler as described above. The layers may also be described as cross-sections or slices. The plurality of layers is ordered, such that the layers may be numbered or organized from a first layer to a last layer.

Step 412 of method 400 includes depositing raw material on a build platform 518 located in a building environment 520 of printer 510. The build platform may comprise a support 517 moveable by computer controller 512 along a manufacturing axis 522. The build platform may have a planar surface 530, perpendicular to manufacturing axis 522.

The raw material may be any material appropriate to DMLS, typically a metal powder including but not limited to an alloy of copper, aluminum, stainless steel, cobalt chrome, titanium, and/or tungsten. The powder may be distributed from a source 524 such as a hopper, a tank, or a powder bed. For example, aluminum powder may be swept from an ascending powder hopper 523 of source 524, over build platform 518, by a recoater blade 532 actuated by computer controller 512.

The metal powder may be distributed evenly over build platform 518 by recoater blade 532. In some examples, build platform 518 is submerged in raw material and depositing is accomplished by gravity or fluid pressure. In some examples, a print head 526 connected to source 524 deposits a raw material in a pattern corresponding to the first layer of the ordered plurality of layers.

At step 414, the metal powder is altered to produce the first layer. In other words, a physical change is induced the deposited material, according to the design information describing the first layer of the ordered plurality of layers and as directed by the computer controller 512, to realize the first layer as a physical object on the build platform.

The material may be acted on by a print head 526 of printer 510, controlled by computer controller 512. In the present example, the print head includes a laser that sinters the metal powder by exposure to heat. In some examples, the print head cures a photopolymer by exposure to light, or otherwise induces a change appropriate to the raw material used. The print head may be directed by computer controller 512 to follow a path delineated in the received digital information for the first layer, and/or a path calculated by processor 514 based on the received digital information. The laser beam may be directed along the delineated path by one or more scanning mirrors 534.

Step 416 includes repositioning the build platform. In some examples, build platform 518 starts a selected distance from print head 526. The selected distance may be determined by the procedures performed by the print head. Subsequent to production of a layer, the build platform may be repositioned by computer controller 512 along manufacturing axis 522 away from print head 526 by the layer's thickness. That is, the build platform may be moved such that a top surface of the produced layer is the selected distance from print head 526.

In some examples, build platform 518 starts in alignment with another element of printer 510, such as a raw material distribution component. Subsequent to production of a layer, the build platform may be repositioned by computer controller 512 along manufacturing axis 522 such that a top surface of the produced layer is aligned with the other element of printer 510. In some examples, at step 416 print head 526 is repositioned instead of or in addition to build platform 518. In some examples, step 416 is skipped.

At step 418, raw material is deposited on the layer produced in the preceding step of method 400. As described for step 412, the raw material may be any appropriate material and may be deposited any appropriate manner. At step 420, the raw material is altered to produce the next layer as previously described for step 414.

Steps 416 through 420 may be repeated to produce each layer of the plurality of layers of the received digital information, until the last layer is produced. The produced first through last layers may then comprise workpiece 528 as described in the received digital information. The workpiece may be removed from the printer and post-processed as desired. For example, the workpiece may be machined from a build plate of the build platform, and then fine details or smooth surfaces may be further finished by machining or other methods.

### C. Illustrative Method of Manufacturing a Heat Exchanger

This section describes steps of an illustrative method 600 of manufacturing a heat exchanger; see FIG. 15. Aspects of heat exchangers, methods of additive manufacture, and/or additive manufacturing apparatus described above may be utilized in the method steps described below. Where appropriate, reference may be made to components and systems that may be used in carrying out each step. These references are for illustration, and are not intended to limit the possible ways of carrying out any particular step of the method.

FIG. 15 is a flowchart illustrating steps performed in an illustrative method, and may not recite the complete process or all steps of the method. FIG. 15 illustrates an example method 600 of manufacturing a heat exchanger. Although various steps of method 600 are described below and depicted in FIG. 15, the steps need not necessarily all be performed, and in some cases may be performed simultaneously or in a different order than the order shown.

At step 610, the method includes printing a main body. The main body may include a casing or housing as well as input and output ports. In some examples, the main body is a rectangular structure of six walls, including at least two apertures configured for connection to a fluid system including valves, threaded fittings, and/or seals. The main body may further include walls defining channels or pipes for direction of fluid flow, as well as plates, fins, and/or other structures configured to facilitate heat transfer.

Step 612 of the method includes printing a plurality of wavy fins. The wavy fins are disposed in the main body and define flow paths for heat transfer from or to a fluid. Each fin has a periodic shape such as sinusoidal, s-shaped, herringbone, triangle-wave and/or any desirable shape. Preferably, the fin is shaped to increase surface area and improve heat transfer.

In some examples, the plurality of wavy fins is arranged as an array of wavy fins. That is, the wavy fins are arranged in generally parallel lines, which may form a planar layer. In some examples, printing the plurality of wavy fins includes printing stacked arrays of wavy fins, or multiple layers of wavy fins. The layers of wavy fins may alternate with another structure and/or may alternate in orientation.

Within examples, method 600 includes sub-step 614 of step 612. Sub-step 614 of step 612 includes printing an inner wall forming a channel with radiused corners. Sub-step 614 is performed for each wavy fin of the plurality of wavy fins printed in step 612, such that each wavy fin includes an inner wall that forms a channel with radiused corners. The inner wall may include four sides, which connect at the radiused corners, forming a generally rectangular cross-sectional shape of the channels. Each channel and radiused corners extends a full length of the respective fin, such that the channel is open at each end of the fin.

Within examples, method 600 includes step 616. Step 616 of method 600 includes printing at least one rib on the inner wall of each wavy fin. The rib extends from the inner wall into the channel of the fin, and is configured to effect desired modifications to fluid flow through the channel. For example, the rib may reduce pressure drop through the channel and/or may increase flow mixing. The rib may have a curved surface, such as a semi-ellipsoid surface. The rib may be linear, may form a continuous ring, and/or have any effective shape.

In some examples, printing at least one rib on the inner wall of each wavy fin includes printing at least one rib in each wave segment of each wavy fin, where the wavy fin can be described as comprising a plurality of wave segments according to the periodic shape of the wavy fin. In some examples, printing at least one rib includes printing a repeating pattern of ribs and/or printing clusters of ribs.

Each of steps 610-616 may be performed concurrently and/or sequentially, according to a selected build orientation of the manufactured heat exchanger. That is, all steps may be performed as part of a single print run or additive manufacturing process. In such examples, the resulting heat exchanger is therefore a monolithic structure, including the main body, plurality of wavy fins, channels, and ribs. In some examples, auxiliary components of the heat exchanger such as input or output ports are separately manufactured and/or added during post-processing of the printed heat exchanger structure.

In some examples, method 600 further includes post-processing of the printed structure, including but not limited to removal of external sacrificial support structures, surface smoothing, and/or machining of threaded connectors. In some examples, the heat exchanger is designed and/or oriented such that no sacrificial support structures are required. Preferably, the heat exchanger does not require removal of internal support structures. For example, heat exchanger 210 as described above can be manufactured without printing and removal of internal support structures.

### D. Illustrative Aircraft and Associated Method

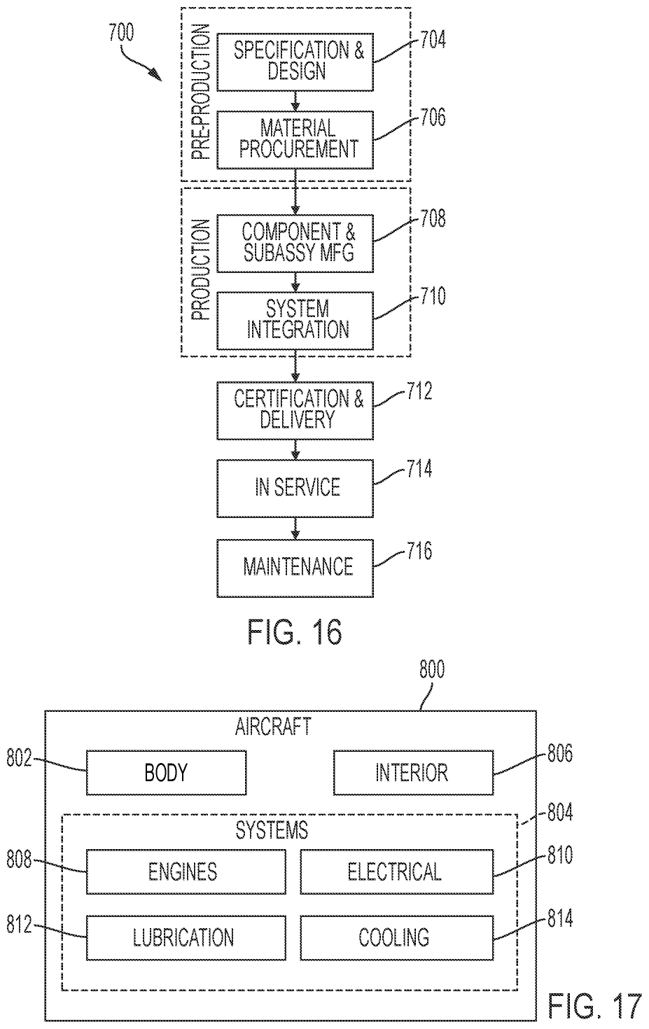

Examples disclosed herein are described in the context of an illustrative aircraft manufacturing and service method 700 (see FIG. 16) and an illustrative aircraft 800 (see FIG. 17). Method 700 includes a plurality of processes, stages, or phases. During pre-production, method 700 includes a specification and design phase 704 of aircraft 800 and a material procurement phase 706. During production, a component and subassembly manufacturing phase 708 and a system integration phase 710 of aircraft 800 take place. Thereafter, aircraft 800 goes through a certification and delivery phase 712 to be placed into in-service phase 714. While in service (e.g., by an operator), aircraft 800 may be scheduled for routine maintenance and service 716 (which may also include modification, reconfiguration, refurbishment, and so on of one or more systems of aircraft 800). While the examples described herein relate generally to operational use during in-service phase 714 of aircraft 800, they may be practiced at other stages of method 700.

Each of the processes of method 700 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 17, aircraft 800 produced by illustrative method 700 includes an aircraft body or frame 802 with a plurality of systems 804 and an interior 806. Examples of plurality of systems 804 include one or more of an engine system 808, an electrical system 810, a lubrication system 812, and a cooling system 814. Each system comprises various subsystems, such as controllers, processors, actuators, effectors, motors, generators, etc., depending on the functionality involved. Any number of other systems may be included. The engine system 808 includes an engine connected to the aircraft body and configured to power the aircraft body in a flight mode. Cooling system 814 of aircraft 800 includes a heat exchanger device configured to cool oil from the engine, the heat exchanger device having a plurality of wavy fins in a main body, the main body and wavy fins being a single monolithic unit, wherein each wavy fin has an inner wall forming a channel including radiused corners throughout a length of the wavy fin. For instance, in an example, aircraft 800 includes heat exchanger 110. In another example, aircraft 800 includes heat exchanger 210.

Although an aerospace example is shown, the principles disclosed herein may be applied to other industries, such as the automotive industry, rail transport industry, and nautical engineering industry. Accordingly, in addition to aircraft 800, the principles disclosed herein may apply to other vehicles, e.g., land vehicles, marine vehicles, etc. Apparatuses and methods shown or described herein may be employed during any one or more of the stages of the manufacturing and service method 700. For example, components or subassemblies corresponding to component and subassembly manufacturing phase 708 may be fabricated or manufactured in a manner similar to components or subassemblies produced while aircraft 800 is operating during in-service phase 714. Also, one or more examples of the apparatuses, methods, or combinations thereof may be utilized during manufacturing phase 708 and system integration phase 710, for example, by substantially expediting assembly of or reducing the cost of aircraft 800. Similarly, one or more examples of the apparatus or method realizations, or a combination thereof, may be utilized, for example and without limitation, while aircraft 800 is in in-service phase 714 and/or during maintenance and service phase 716.

### Illustrative Combinations and Additional Examples

This section describes additional aspects and features of additively manufactured heat exchangers, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. An additively manufactured heat exchanger comprising:

a main body;

a plurality of wavy fins disposed in the main body to define flow paths for heat transfer, each wavy fin having an inner wall forming a channel including radiused corners throughout a length of the wavy fin.

A1. The additively manufactured heat exchanger of A0, wherein the inner wall has at least one rib.

A2. The additively manufactured heat exchanger of A1, wherein the at least one rib comprises a rib forming a continuous ring around an inner circumferential surface of the inner wall.

A3. The additively manufactured heat exchanger of A1 or A2, wherein the at least one rib comprises a first rib having a long axis perpendicular to a direction of fluid flow through the channel.

A4. The additively manufactured heat exchanger of any of A1-A3 wherein the at least one rib comprises a first rib, the wall of the channel has first, second, third, and fourth sides, and the first rib protrudes inwardly from the first side of the wall.

A5. The additively manufactured heat exchanger of A4, wherein the at least one rib further comprises a second rib separate from the first rib, protruding inwardly from the second side of the wall into the channel.

A6. The additively manufactured heat exchanger of A5, wherein the first rib has a long axis perpendicular to a direction of fluid flow through the channel, and the second rib has a long axis parallel to the direction of fluid flow.

A7. The additively manufactured heat exchanger of A5 or A6, wherein the third side of the wall has a third rib, separate from the first and second ribs, protruding into the channel.

A8. The additively manufactured heat exchanger of A7, wherein the fourth side of the wall has a fourth rib, separate from the first, second, and third ribs, protruding into the channel.

A9. The additively manufactured heat exchanger of any of A4-A8, wherein the first side of the wall has a second rib extending into the channel.

A10. The additively manufactured heat exchanger of any of A1-A9, wherein the inner wall and the at least one rib are part of a single monolithic unit.

A11. The additively manufactured heat exchanger of any of A1-A10, wherein each rib of the at least one rib has a semi-ellipsoid surface.

A12. The additively manufactured heat exchanger of any of A1-A11, wherein each wavy fin has a periodic wave shape along the length of the wavy fin, the at least one rib of the wavy fin comprising multiple ribs, and each of the multiple ribs being disposed in the channel of the wavy fin at a corresponding point in the period of the wave shape.

A13. The additively manufactured heat exchanger of A12, wherein one of the multiple ribs is disposed in each period along the length of the wavy fin.

A14. The additively manufactured heat exchanger of A12, wherein one of the multiple ribs is disposed in every other period along the length of the wavy fin.

A15. The additively manufactured heat exchanger of any of A0-A14, wherein the main body and the plurality of wavy fins are a single monolithic unit.

A16. The additively manufactured heat exchanger of any of A0-A15, wherein the plurality of wavy fins are formed in multiple stacked arrays.

A17. The additively manufactured heat exchanger of any of A0-A16, wherein the main body has an intake valve configured for receiving hot oil from an aircraft engine, and an out-take valve configured for channeling cooled oil out of the main body after exchanging heat with air passing through the channels of the plurality of wavy fins.

B0. An aircraft, comprising:

an aircraft body,

an engine connected to the aircraft body and configured to power the aircraft body in a flight mode,

a heat exchanger device configured to cool oil from the engine, the heat exchanger device having a plurality of wavy fins in a main body, the main body and wavy fins being a single monolithic unit,

wherein each wavy fin has an inner wall forming a channel including radiused corners throughout a length of the wavy fin.

B1. The aircraft of B0, wherein the main body and plurality of wavy fins are additively manufactured.

B2. The aircraft of B0 or B0, wherein the wall of the channel has at least one rib protruding into the channel.

B3. The aircraft of B2, wherein the at least one rib comprises a rib forming a continuous ring around an inner circumferential surface of the inner wall.

B4. The aircraft of B2 or B3, wherein each rib of the at least one rib has a semi-ellipsoid surface.

C0. A method of manufacturing a heat exchanger, comprising:

printing a main body, and

printing a plurality of wavy fins inside the main body.

C1. The method of C0, wherein printing the plurality of wavy fins comprises printing, for each wavy fin, an inner wall forming a channel including radiused corners throughout a length of the wavy fin.

C2. The method of C0 or C1, further comprising: printing at least one rib on an inner wall of each of the wavy fins.

### Advantages, Features, and Benefits

The different examples of the additively manufactured heat exchanger described herein provide several advantages over known solutions for thermal management of fluids. For example, illustrative examples described herein allow manufacture of a heat exchanger with reduced assembly time and part count.

Additionally and among other benefits, illustrative examples described herein reduce or eliminate joins and fastenings.

Additionally, and among other benefits, the unitary structure and single material construction of illustrative examples described herein improve heat transfer.

Additionally and among other benefits, illustrative examples described herein optimize fluid flow for enhanced heat transfer and reduced fluid pressure drop.

No known system or device can perform these functions, particularly with reduced weight a smaller footprint than traditionally manufactured heat exchangers. Thus, the illustrative examples described herein are particularly useful for aircraft oil coolers. However, not all examples described herein provide the same advantages or the same degree of advantage.

### CONCLUSION

The disclosure set forth above may encompass multiple distinct examples with independent utility. Although each of these has been disclosed in its preferred form(s), the specific examples thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. An additively manufactured heat exchanger comprising:
a main body;
a plurality of wavy fins disposed in the main body to define flow paths for heat transfer, each wavy fin having an inner wall forming a channel including radiused corners throughout a length of the wavy fin.

2. The additively manufactured heat exchanger of claim 1, wherein the inner wall has at least one rib.

3. The additively manufactured heat exchanger of claim 2, wherein the at least one rib comprises a rib forming a continuous ring around an inner circumferential surface of the inner wall.

4. The additively manufactured heat exchanger of claim 2, wherein the at least one rib comprises a first rib having a long axis perpendicular to a direction of fluid flow through the channel.

5. The additively manufactured heat exchanger of claim 2, wherein the at least one rib comprises a first rib and a second rib, the wall of the channel has first and second sides, the first rib protrudes inwardly from the first side of the wall, and the second rib protrudes inwardly from the second side of the wall.

6. The additively manufactured heat exchanger of claim 5, wherein the first rib has a long axis perpendicular to a direction of fluid flow through the channel, and the second rib has a long axis parallel to the direction of fluid flow.

7. The additively manufactured heat exchanger of claim 2, wherein the inner wall and the at least one rib are part of a single monolithic unit.

8. The additively manufactured heat exchanger of claim 2, wherein each rib of the at least one rib has a semi-ellipsoid surface.

9. The additively manufactured heat exchanger of claim 2, wherein each wavy fin has a periodic wave shape along the length of the wavy fin, the at least one rib of the wavy fin comprising multiple ribs, and each of the multiple ribs being disposed in the channel of the wavy fin at a corresponding point in the period of the wave shape.

10. The additively manufactured heat exchanger of claim 9, wherein one of the multiple ribs is disposed in each period along the length of the wavy fin.

11. The additively manufactured heat exchanger of claim 1, wherein the main body and the plurality of wavy fins are a single monolithic unit.

12. The additively manufactured heat exchanger of claim 1, wherein the main body has an intake valve configured for receiving hot oil from an aircraft engine, and an out-take valve configured for channeling cooled oil out of the main body after exchanging heat with air passing through the channels of the plurality of wavy fins.

13. An aircraft, comprising:
an aircraft body,
an engine connected to the aircraft body and configured to power the aircraft body in a flight mode,
a heat exchanger device configured to cool oil from the engine, the heat exchanger device having a plurality of wavy fins in a main body, the main body and wavy fins being a single monolithic unit,
wherein each wavy fin has an inner wall forming a channel including radiused corners throughout a length of the wavy fin.

14. The aircraft of claim 13, wherein the main body and plurality of wavy fins are additively manufactured.

15. The aircraft of claim 13, wherein the wall of the channel has at least one rib protruding into the channel.

16. The aircraft of claim 15, wherein the at least one rib comprises a rib forming a continuous ring around an inner circumferential surface of the inner wall.

17. The aircraft of claim 15, wherein each rib of the at least one rib has a semi-ellipsoid surface.

18. A method of manufacturing a heat exchanger, comprising:
printing a main body, and
printing a plurality of wavy fins inside the main body.

19. The method of claim 18, wherein printing the plurality of wavy fins comprises printing, for each wavy fin, an inner wall forming a channel including radiused corners throughout a length of the wavy fin.

20. The method of claim 18, further comprising:
printing at least one rib on an inner wall of each of the wavy fins.
